(19) United States
(12) Patent Application Publication
(10) Pub. No.: US 2010/0207399 A1
(43) Pub. Date: Aug. 19, 2010

(54) PYRAMID ELECTRIC GENERATOR

(76) Inventor: Peter Grandics, Carlsbad, CA (US)

Correspondence Address: Law Offices of Michael B. Farber, 1902 Wright Place, Suite 200, Carlsbad, CA, 92008, US

(21) Appl. No.: 12/689,351

(22) Filed: Jan. 19, 2010

Related U.S. Application Data
(63) Continuation-in-part of application No. 12/140,887, filed on Jun. 17, 2008.
Application No. 12/140,887 is a continuation-in-part of application No. PCT/US07/69804, filed on May 25, 2007.
(60) Provisional application No. 60/818,360, filed on Jul. 3, 2006.

(51) Int. Cl. H02K 57/00

(52) U.S. Cl. 290/1 R

(57) ABSTRACT

A pyramid electric generator for harvesting the vibrational energies of Earth's atomic oscillators according to the present invention comprises: (1) an antenna/waveguide that is geometrically optimized; (2) a coil wound with an insulated conductor on a nonconductive coil form, the coil being connected at its top lead to the conducting surface of the antenna/waveguide such that the coil is connected near the point at which the electric field contacts the antenna/waveguide, the antenna/waveguide serving as a quasi-capacitive series element to provide a specific resonant frequency; (3) the bottom lead of the coil is connected to a driver operating in the LF or ELF bands. In another mode of operation, a secondary coil is positioned coaxially within the first coil acting as a resonant step-up transformer winding. The generator resonantly couples into specific frequencies of Earth's atomic oscillators and extracts electric energy thereof.

### CROSS-REFERENCES

This application is a continuation-in-part of U.S. patent application Ser. No. 12/140,887 by Grandics, entitled “The Pyramid Electric Generator,” and filed on Jun. 17, 2008, which was a continuation-in-part of PCT Application Serial No. PCT/U.S.07/69804 by Grandics, entitled “An Electric Power Converter for Extraction of Atmospheric Electrical Energy,” designating the United States and filed on May 25, 2007, which in turn claimed priority from U.S. Provisional Application Ser. No. 60/818,360 by Grandics, also entitled “An Electric Power Converter for Extraction of Atmospheric Electrical Energy,” and filed on Jul. 3, 2006. The specifications of these three prior applications are incorporated herein in their entirety by this reference.

### BACKGROUND OF THE INVENTION

This invention relates to the generation of electrical power by drawing energy from Earth's electric field. Earth represents a resonant system in which both atmospheric and telluric electrical processes can be harvested. In U.S. Pat. No. 6,974,110, we have provided an apparatus and method for converting the electrostatic potential energy of Earth's atmosphere into usable power. The present invention aims to provide an electric generator that, in addition to tapping atmospheric electric processes, extracts electrical power from the vibrational energy of atomic oscillators by a novel resonant coupling method.

### SUMMARY OF THE INVENTION

An electrical generator according to the present invention provides a new method of tapping Earth's electric energy field.

One aspect of the present invention is an apparatus for capturing both atmospheric and telluric electric energies, comprising:

(1) an antenna/waveguide that is geometrically optimized having a conducting surface; and

(2) a coil wound with an insulated conductor over a non-conductive coil form, the coil being connected to an AC or AC-DC driver at its bottom lead and, by its top lead to the conducting surface of the antenna/waveguide near the point where the electric field contacts the antenna/waveguide, with the antenna/waveguide serving as a quasi-capacitive series element to provide a specific resonant frequency;

wherein the generator absorbs impulses from Earth's electric oscillations; and
wherein the attracted energy manifests as high voltage sinusoidal waveforms in the coil, representing harvested electrical energy of atomic oscillators and measurable on the leads of the coil.

Preferably, the antenna/waveguide is of pyramidal shape. When the antenna/waveguide is of pyramidal shape, the apex/primary coil is preferably connected near or at the apex of the antenna/waveguide.

Another aspect of the invention is an electric generator for harvesting the energies of atomic oscillators comprising:

(1) an antenna/waveguide that is geometrically optimized having a conducting surface; and

(2) a primary (apex) coil wound with an insulated conductor over a non-conductive coil form, the coil being connected to an AC or AC-DC driver at its bottom lead and, by its top lead to the conducting surface of the antenna/waveguide near the point where the electric field contacts the antenna/waveguide, and the antenna/waveguide serving as a quasi-capacitive series element to provide a specific resonant frequency; and

(3) a secondary coil of smaller diameter than the primary (apex) coil having a greater number of turns than the primary coil, the secondary coil being positioned coaxially within the primary coil and acting as a resonant step-up transformer winding inductively coupled with the primary coil;

wherein the generator absorbs impulses from Earth's electric oscillations; and
wherein the attracted energy manifests as high voltage sinusoidal waveforms in the secondary coil, representing harvested electrical energy of atomic oscillators and measurable on the leads of the secondary coil.

Yet another aspect of the present invention is an electric generator for harvesting the electric emissions of atomic oscillations comprising an oscillator. In this aspect, the electric generator typically comprises:

(1) a primary (apex) coil wound with a conductor over a secondary coil, the primary coil being connected electrically at its bottom lead to a driver operating in the LF or ELF bands while connected by its top lead near the point at which the electric field contacts the conductive surface of the antenna/waveguide; and

(2) a secondary coil of smaller diameter than the primary (apex) coil having a greater number of turns than the primary coil, the secondary coil being positioned coaxially within the first coil and acting as a resonant step-up transformer winding inductively coupled with the primary;

wherein said resonant step-up transformer's output voltage exceeds 500 V_{RMS};
wherein the electric generator attracts impulses from Earth's electric oscillations;
and wherein the attracted energy manifests as high voltage sinusoidal waveforms representing harvested electric energy of atomic oscillations in the secondary coil.

Another aspect of the present invention is a method of tapping Earth's electric energy field, comprising the steps of:

(1) positioning an electric generator according to the present invention as described above such that it is exposed to Earth's electric oscillations; and

(2) generating a sinusoidal voltage signal representing harvested electric energy of atomic oscillators by the operation of the generator.

### BRIEF DESCRIPTION OF THE DRAWINGS

The following invention will be better understood with reference to the specification, appended claims, and accompanying drawings, where:

FIG. 1 is a graph showing the formation of electric vortices across and around the pyramid.

FIG. 2 is a graph showing the circuit diagram and measurement points of the pyramid generator.

FIG. 3 is a graph showing the minimum circuit diagram and relevant measurement points of the pyramid generator.

### DETAILED DESCRIPTION OF THE INVENTION

One aspect of the invention is an apparatus for capturing atmospheric and telluric electric energies, comprising:

(1) an antenna/waveguide that is geometrically optimized having a conducting surface; and

(2) a coil wound with an insulated conductor over a non-conductive coil form, the coil being connected to an AC or AC-DC driver at its bottom lead and, by its top lead to the conducting surface of the antenna/waveguide near the point where the electric field contacts the antenna/waveguide, with the antenna/waveguide serving as a quasi-capacitive series element to provide a specific resonant frequency;

wherein the generator absorbs impulses from Earth's electric oscillations; and
wherein the attracted energy manifests as high voltage sinusoidal waveform in the coil, representing harvested electrical energy of atomic oscillators and measurable on the leads of the coil.

Typically, the electric generator stimulates and attracts the electric emissions of atomic oscillators by the use of high voltage. Typically, the antenna/waveguide is designed based on functions of phi and/or pi.

In one alternative, the antenna/waveguide is placed on an insulated base.

Typically, the antenna/waveguide is at a high voltage during the operation of the generator. Typically, the antenna/waveguide voltage is measured by using an E-field antenna.

The antenna/waveguide can be connected to an oscillator. The oscillator can be a resonant step-up transformer.

Preferably, the antenna/waveguide is of pyramidal shape. Preferably, the antenna/waveguide exhibits functions of phi and/or pi. However, any geometric form employing these functions can be used for the antenna/waveguide. When it is of pyramidal shape, the primary (apex) coil is preferably connected near or at the apex of the antenna/waveguide. The shape and size of the antenna/waveguide can be optimized depending on the intended use of the generator.

Typically, the generator further comprises an insulating base on which the antenna/waveguide is placed. The size and shape of the insulating base can also be optimized, depending on the intended use of the generator.

Typically, the output of the apex coil-antenna/waveguide series resonant circuit or that of the secondary coil is harvested. One way to do this is by connecting to a step-down transformer and rectifier-capacitor-load resistance. The optimal circuit can be selected by one of ordinary skill in the art to optimize power extraction. The load draws power from the generator.

The driver can supply AC or a combination of AC-DC power to activate the resonant circuit.

Typically, the antenna/waveguide is positioned in the general North-South direction. In this arrangement, when the antenna/waveguide is of pyramidal shape, the height of the pyramid can vary from about 0.1 m to about 1000 m. The optimal pyramid size is a function of the power requirements. However, a pyramid can be built as high as 1 km in height. The base surface area of the pyramid may range from about 0.01 m² to about 1,000,000 m². Naturally, other heights and base surface areas or shapes can be used for particular applications. The numbers of sides can also vary. When the pyramid is small (e.g., the 6.26 feet base length described in this application), there is an insufficient atmospheric potential gradient on its apex to trigger the attraction of energy. In such event, a driver is necessary to bring the pyramid to the electric potential necessary for its harvesting function.

Another embodiment of the present invention is an electric generator for harvesting the energies of atomic oscillators comprising:

(1) an antenna/waveguide that is geometrically optimized having a conducting surface; and

(2) a primary (apex) coil wound with an insulated conductor over a non-conductive coil form, the coil being connected to an AC or AC-DC driver at its bottom lead and, by its top lead to the conducting surface of the antenna/waveguide near the point where the electric field contacts the antenna/waveguide, and the antenna/waveguide serving as a quasi-capacitive series element to provide a specific resonant frequency; and

(3) a secondary coil of smaller diameter than the primary (apex) coil having a greater number of turns than the primary coil, the secondary coil being positioned coaxially within the primary coil and acting as a resonant step-up transformer winding inductively coupled with the apex coil;

wherein the generator absorbs impulses from Earth's electric oscillations; and
wherein the attracted energy manifests as high voltage sinusoidal waveforms in the secondary coil, representing harvested electrical energy of atomic oscillators and measurable on the leads of the secondary coil.

In this embodiment, more than one resonant step-up transformer winding can be used. As described above for the first embodiment, in this embodiment, the electric generator stimulates and attracts the electric emissions of atomic oscillators by the use of high voltage. Typically, in this embodiment, the antenna/waveguide is designed based on functions of phi and/or pi. In one alternative, in this embodiment, the antenna/waveguide is placed on an insulated base. Typically, in this embodiment, the generator further comprises an insulating base on which the antenna/waveguide is placed. Typically, in this embodiment, antenna/waveguide is at a high voltage during the operation of the generator. Typically, in this embodiment, the antenna/waveguide voltage is measured by using an E-field antenna. In this embodiment, the antenna/waveguide can be connected to an oscillator. The oscillator can be a resonant step-up transformer. Preferably, in this embodiment, the antenna/waveguide is of pyramidal shape. Preferably, in this embodiment, the antenna/waveguide exhibits functions of phi and/or pi. Typically, in this embodiment, the antenna/waveguide is positioned in the general North-South direction. In this embodiment, in this arrangement, when the antenna/waveguide is of pyramidal shape, the height of the pyramid can vary from about 0.1 m to about 1000 m. The optimal pyramid size is a function of the power requirements. However, a pyramid can be built as high as 1 km in height. In this embodiment, the base surface area of the pyramid may range from about 0.01 m² to about 1,000,000 m².

In this embodiment, typically, the primary (apex) coil of the resonant transformer is connected near the point where the electric field contacts the antenna/waveguide.

In this embodiment, typically, the bottom lead of the secondary coil is connected to ground. In this embodiment, typically, the primary (apex) coil is inductively coupled to the secondary coil.

In this embodiment, typically, the output of the secondary coil is connected to a load for drawing power from the generator.

Another embodiment of the present invention is an electric generator for harvesting the electric emissions of atomic oscillations comprising an oscillator.

In this embodiment, typically, the oscillator operates in the LF or ELF bands.

Typically, in this embodiment, the electric generator comprises:

(1) a primary (apex) coil wound with a conductor over a secondary coil, the primary (apex) coil being connected electrically at its bottom lead to a driver operating in the LF or ELF bands while connected by its top lead near the point at which the electric field contacts the conductive surface of the antenna/waveguide; and

(2) a secondary coil of smaller diameter than the primary coil having a greater number of turns than the primary coil, the secondary coil being positioned coaxially within the first coil and acting as a resonant step-up transformer winding inductively coupled with the primary;

wherein said resonant step-up transformer's output voltage exceeds 500 V_{RMS};
wherein the electric generator attracts impulses from Earth's electric oscillations;
and wherein the attracted energy manifests as high voltage sinusoidal waveforms representing harvested electric energy of atomic oscillations in the secondary coil.

In this embodiment, typically, the output of the secondary coil is connected to a load for drawing power from the generator.

Another aspect of the invention is a method of tapping Earth's electric energy based on the following concepts:

(1) utilizing a pyramidal antenna/waveguide designed based on the functions of phi and/or pi;

(2) using the antenna/waveguide to absorb and focus specific frequencies of Earth's electric field;

(3) positioning a coil(s) connected to the pyramidal antenna/waveguide near or at its apex according to the present invention; and

(4) generating a high-voltage sinusoidal signal, representing harvested atmospheric and telluric electrical energy, by the operation of the system.

Typically, the harvested electric energy can be fed into a power grid for distribution, but smaller units capable of distributed power generation or for use as stand-alone generators are also feasible by the concept of this invention.

In this aspect, the method typically comprises a method of tapping Earth's electric oscillatory energies comprising the steps of:

(1) positioning an electric generator according to the present invention as described above such that it is exposed to Earth's electric oscillations; and

(2) generating a sinusoidal voltage signal representing harvested electric energy of atomic oscillators by the operation of the generator.

The invention is described by the following Example. This Example is included for illustrative purposes only and is not intended to limit the invention.

### Example

We have introduced a new theory of space, energy and matter that predicted that electromagnetic interaction propagates through a carrier medium called the space lattice that is made up of pulsating, phi-based spiral vortices (STAR), the excitation of which generates propagating sinusoidal lines of force across the space lattice recorded as electromagnetic waves by our instruments [1,2]. We have also predicted that natural pressure gradients exist within the space lattice that can be used for power generation by inserting a capacitor into such gradient. Furthermore, we proposed that a pyramid-shaped capacitor is an optimally shaped device for tapping the energy gradient of the space lattice that manifests in the form of an electrical potential gradient in Earth's atmosphere. This was subsequently demonstrated [3-5]. We also found that the pyramid-shaped capacitor design should be based on functions of phi and/or pi [5] because electrical energy propagates along a phi-based spiral [6].

We suggested that elemental particles are composed of STAR oscillators that make up the space lattice by electromagnetic compression of its elemental cubes into pulsating conical/vortexual subunits that form the basis for all particles of matter [1,2]. We proposed that atomic and subatomic oscillators could vibrate in a very wide frequency range from sub-acoustic to extremely high EM frequencies [1,2]. This does not mean that material bodies can take or maintain a physical form at any energy level, but this allows the recycling of atoms into the space lattice as part of their natural evolution [2,6].

Atomic oscillators are constantly in motion, and such motion is electric because all motion and energy is fundamentally electric [2,6]. It is known that atomic bodies constantly exchange electric energy. Such energy flow can be harvested when the spiral physical nature of electric waves is recognized. Russell observed that energy moves during its generative cycle in spirals towards the higher potential [7]; therefore, we reasoned that an “attractor” of high electric potential must be provided to pull in the random electromagnetic emissions of atomic oscillators. The “attractor” must function as a phi-based antenna/waveguide to focus the phi-based electric emissions of atomic bodies into the apex of a vortex, the same method Nature uses for power multiplication [6,7]. Therefore, a phi-based pyramidal antenna/waveguide must be at a high voltage in order to perform its attractor function.

To achieve this goal, a geometrically optimized pyramidal antenna/waveguide must be connected to an oscillator that operates at a high voltage and is tuned to a suitably selected frequency.

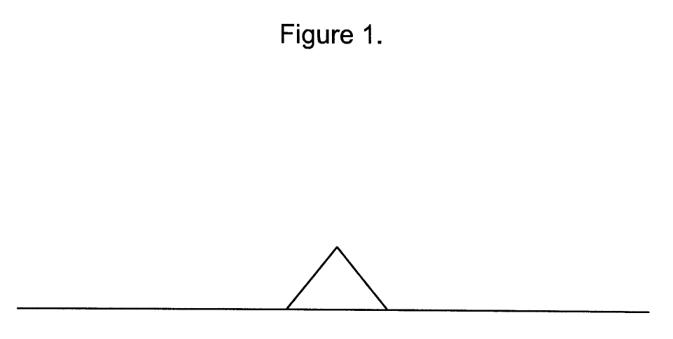

The appropriate resonant frequency is dictated by practical considerations. Atomic oscillators can vibrate in a very wide frequency range [1, 2, 7, 8] but short wavelength radiations are readily re-absorbed by atoms and are rapidly attenuated; therefore, long wavelength electromagnetic emissions should be targeted. The operation of the pyramid generator is most practical in the ELF to the LF range. As electric radiation propagates in a vortex [2,7,8], the emitted electric vortex over the pyramidal antenna (FIG. 1) increases its “size,” and so it is capable of funneling atmospheric electromagnetic emissions of the same frequency back into the antenna/receiver. Thus, the pyramid electric generator could capture the energy emitted by both telluric and atmospheric atomic oscillators. We have tested these assumptions and demonstrated the basic principles of an electric generator.

### Methods and Results

In our previous paper, we reported on a pyramid-shaped capacitor/antenna connected in series to a coil that form a resonant circuit for harvesting an expanded range of atmospheric and telluric electric energies [6]. As the signals in the pyramid energy harvester system are at extremely high voltages, we have developed a measurement and control system that allows secure remote transmission of test signals with great accuracy while removing all the hazards associated with direct connection of ultra-high voltages (over 50 kV AC) to the measurement and data-logging system. The voltage and current signals measured across a resistor are turned into a proportional electronic signal, which is then fed to a light emitting diode (opto transmitter) and sent through an optical cable to the instrumentation part of the system where it is converted back by an opto receiver module into an electronic signal for acquisition and processing by the National Instrument PXI 1042Q controller programmed with Labview 6. An ENI-1140LA amplifier was used to activate the oscillator at the resonant frequency.

For the experiments, we used a novel tetrahedral pyramid-shaped antenna/waveguide that expressed the golden mean in its ratios. The base length of the pyramidal antenna was 6.26 feet. The pyramid was built of a wooden frame and covered with 26 AWG triangular copper sheets on its sides that were electrically connected. It was placed on an insulating base and positioned in the general North-South direction.

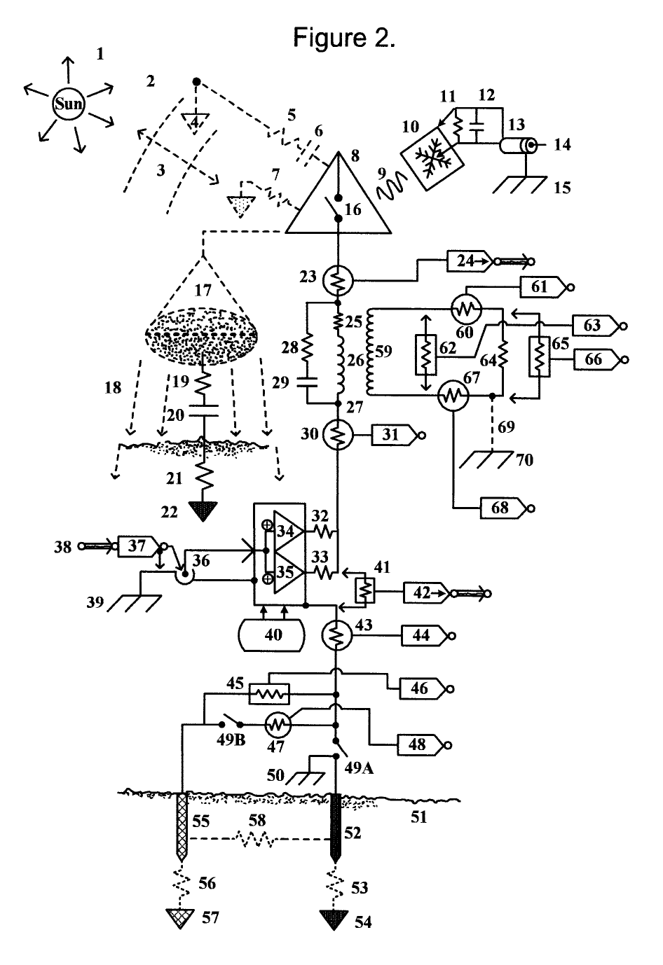

The apex coil was wound on a HDPE cylindrical coil form using a 14 AWG insulated magnet wire with a monofilament spacer polyester twine (0.05″ diameter) between the turns, and connected to the conducting surface of the pyramid near its apex. Thus, the apex coil is connected to the pyramidal antenna/waveguide acting as a quasi-capacitive series element to provide a specific resonant frequency by coupling to the ambient electromagnetic environment. The bottom lead of the apex coil was connected to a driver and grounded via the driver (FIG. 2). The purpose of the monofilament spacer is to reduce interwinding capacitance in the apex coil by increasing distance between wire turns of the coil.

The parameters of the apex coil are shown in Table 1.

TABLE 1
Physical and electrical parameters of the apex coil

| Number of turns of wire | 290 | |
|---|---|---|
| Coil height | 0.87 | m |
| Coil diameter | 0.787 | m |
| Wire diameter | 1.6277 | mm |
| Inductance | 42.86 | mH |
| Resistance | 6.5 | ohms |

In the experiment, the controlled variable was the voltage, which was increased in steps by the controller until a maximum voltage in the system (permitted by circuit components and test equipment) was achieved for the given resonant frequency. The objective was to “drive the atmosphere and ground” by radiating a high voltage (˜200 kV p-p), LF (˜70 kHz) signal fed by a powerful signal generator at a resonant frequency determined by the pyramid as a quasi-capacitive series element connected to the apex coil and radiating to the local atmosphere and the ground.

The experimental data are shown in Table 2. An apparent power gain of nearly 170-fold was achieved in the resonant circuit relative to input power from the driver.

TABLE 2
Power measurements in the resonant pyramid-coil system.

| Frequency | Drive voltage | Drive current | Drive power | Drive power |
|---|---|---|---|---|
| (kHz) | (rms) | (rms) | (VA) | (W) |
| 70.9 | 321.1 V | 3.2 A | 1125.54 | 735.5 |
| Frequency | Apex voltage | Apex current | Apex power | Apex power |
| (kHz) | (rms) | (rms) | (kVA) | (kW) |
| 70.9 | 67.922 kV | 2.903 A | 196.621 | 40.393 |

A load may be connected to the system to draw power from it. The load may also be connected via a secondary coil inductively coupled to the apex coil. The load may be a resistor, a rectifier or storage capacitor powering a DC load. The high voltage, high frequency output can also be converted to the frequency and voltage of standard mains power.

A graphic representation of the system is shown in FIG. 2. The pyramidal antenna/waveguide, placed on an insulating base, is coupled to the ambient electromagnetic environment and serves as an antenna/waveguide for the harvesting of atmospheric and telluric electromagnetic oscillations at resonance frequency (FIG. 1). The atmospheric electric vortex possibly acts as an ionic antenna pulling in EM radiations from a large atmospheric domain.

The pyramid's apex is connected to a coil of high turn number (FIG. 2). This apex coil wound on a nonconductive coil form forms a resonant circuit with the pyramid that acts as a quasi-capacitive series element. An RF power amplifier activates the apex coil. The measurement points are also indicated, displaying the positions of voltage and current sense resistors and opto-electric transmitters. A detailed description of the system follows in FIG. 2.

The source of radiative and electromagnetic power to earth is the Sun 1, which is harvested by effect of pyramid operations. Solar radiation is separated into light, heat, electromagnetic waves 2 by interaction with atmosphere, magnetosphere, ionosphere. “Electrosphere” 3 comprises of ionized, highly conductive air. It can be understood as a conductive spherical band about 60 mi above the surface of the earth. Virtual “Ground” 4 in electrosphere—a low impedance spherical area that in the circuit may be considered as a “ground” (for non-harvesting calculations) or a variable circuit source (for harvesting calculations). Effective resistive impedance 5 is from pyramid surface to “sky” or “electrosphere” (radiative impedance). Effective capacitive impedance 6 is from pyramid surface to “sky” or “electrosphere”. Effective resistive (conductive) impedance 7 is from pyramid external surface to nearby atmosphere due to “corona” type ionic conduction through ionized air, caused by high peak voltages on the pyramid's surface. Conductive pyramidal transducer/energy harvester 8 is coupled to the ambient electromagnetic environment as above. Radiated “near field” electromagnetic field 9 from pyramid surface (toward “sky”) is measured by E-field antenna 10. The antenna does indirect measurement of pyramid surface voltage based on E-field pick-up of alternating current field within ˜20 ft of pyramid surface, at a particular fixed distance and orientation. Impedance-matching resistor 11 couples E-field antenna to coaxial cable and impedance-matching capacitor 12 for coupling E-field antenna to coaxial cable. Coaxial cable 13 connects to measurement system interface with a “BNC” connector 14 to provide electrical interface to measurement system. System “ground” (common connection point) 15 is for measurement/control system components. Switch 16 is for disconnection of pyramid/antenna from pyramid driving electronics. Radiative “cone” 17 emits from inside and bottom surface of pyramid towards “ground” underneath the pyramid harvester system. Radiated E-M field 18 is directed from pyramid to ground surface directly underneath. Resistive impedance 19 of radiated E-M field (“virtual” component) is derived from measurement and calculation of E-M field model to ground area. Capacitive impedance 20 of radiated E-M field to “ground” area is a “virtual component” derived from measurement and calculation of E-M field model. Virtual resistance of radiated energy 21 from bottom of pyramid, is conducted through earth to “firm ground” potential (another “virtual component” derived from measurement and calculation). Pyramid ground 52 is an equipotential “zero-impedance” point in the earth which serves as the ground reference for both conducted (from pyramid ground stake 52) and radiated 18, 19, 20, 21 energy underneath the pyramid harvester device. In a non-harvesting model this ground point is always at zero potential. However, in an energy-harvesting model the point 22 serves as an AC voltage source, sending conducted energy back into the pyramid system through all the components that “drain” to it in the non-harvesting model. Sense resistor 23 for apex current monitor in pyramid energizing system is a low value resistor (typically 0.05 to 0.2 ohms) that allows a small voltage to develop, proportional to the current flowing to the pyramid apex from the energizing system. Apex current monitor opto transmitter 24 measures the voltage across resistor 23 and turns it into a proportional electronic signal, which is then fed to a light emitting diode and transmitted through an optical cable to the instrumentation part of the system. All the signals in the pyramid harvester system are at extremely high voltages, and the optical cable allows secure remote transmission of these signals to the measurement and data-logging system (not shown on this diagram). Resistance 25 of the apex excitation coil 26 is measured at DC. This is a “virtual” component, since the resistance is in the coil itself, and is not a separate component. Apex coil 26 translates the stimulation power signal from amplifiers 34, 35 into a very high voltage at the resonant frequency established by the coil and intrinsic capacitance of the pyramid. Mutual inductance coupling exists between the apex coil and the harvest or secondary coil 27. This is another “virtual component” consisting of the electromagnetic signal coupling between the two coils based on many different factors. Optional resistor 28 can be used for resonance or phase tuning of pyramid network. The main resonance is determined by apex coil 26 inductance and pyramid lumped capacitive element 8. However, this will make the voltage at the junction of the pyramid (capacitor) and the apex coil 26 approximately 90 degrees out of phase with the current. One approach to reduce the phase angle and also to possibly tune the resonant frequency and the Q of the circuit is to insert an additional reactive element 29 in parallel into the apex coil 26. The apex coil winding resistance is expressed here as resistor 25 in series with inductor 26. The inserted element is an additional optional capacitor 29 in parallel with the apex coil. This capacitor develops an independent L-C resonant circuit, besides the L-C resonant circuit of the apex coil and pyramid. An anticipated function if used in the circuit would be to lower the resonant frequency. Drive current monitor current sense resistor 30 is for drive current opto transmitter 31. Summing/protection resistors are placed in series with 32 drive 1 and 33 drive 2. Power amplifiers 34, 35 drive coil/pyramid resonant system. Power (drive) amplifier signal input 36 is fed through opto receiver 37. The signal in the optical cable 38 is from the National Instruments control system for control of power amplifiers. Pyramid system ground (star-ground) connects to top of pyramid ground stake, after ground stake disconnect switches 39 and 50. Power supply 40 is for pyramid driver amplifier. Resistor 41 is used for voltage measurement across power driver higher value terminals. Opto transmitter 42 is for voltage measurement across power amplifier and includes drawing of optical cable to measurement system. Current-sensing resistor 43 is for current measurement from pyramid amplifiers to ground post. Opto transmitter 44 is for transmitting ground current to control and measurement system. Voltage sense resistor 45 is between pyramid ground stake 52 and remote ground stake 55 (100 kohm-1 Mohm). Opto transmitter 46 is for voltage sense from pyramid ground 52 to remote ground 55. Current sense resistor 47 from pyramid ground to remote ground is for opto transmitter 48. When used, this closes switch 49B to short out the voltage measurement 45 and also short out the intrinsic ground impedance 58 between pyramid ground and remote ground stakes. Ground post disconnect switch 49 is below the system star ground stake and is very dangerous when open. Main connection point for pyramid system is the star ground terminal 50. Ground surface 51 is on which pyramid system is placed. Ground stake 52 for pyramid system is a 1″ diameter copper rod, 8-12 ft deep. R absolute 53 is between ground stake and earth integrated from ground stake theoretically through entire earth. “Absolute ground” is located under pyramid and ground stake 54. Remote ground stake 55 is about 200 feet away from pyramid system and is used as remote reference ground although a real remote ground would likely be much further away. R absolute 56 is from remote ground stake to absolute ground under remote stakes 57. Ground impedance 58 between 52 and 55 stakes appears mostly resistive and is about 28-30 ohms based on AC measurements at 1 KHz. The remote ground setup is not required for the operation of the system but provides test data. Harvest/secondary coil 59 is an inductor wound with 3 to 6 times as many turns as the apex coil, and connected to it by mutual inductance 27. Current sense resistor 60 is placed on top lead of harvest coil. Opto transmitter 61 is for top harvest coil current. Voltage sense resistor 62 that measures voltage across harvest coil is for opto transmitter 63. Load resistor 64 is for secondary/harvest coil and the load resistor is optimized to draw the maximum power from the harvest/secondary coil such that the energy harvest efficiency of the entire system is optimized. This is the defining element of the system. Voltage sense resistor 65 for the opto transmitter for load voltage 66 measures the voltage across the load. Current sense resistor 67 is placed at bottom side of harvest coil. Opto transmitter 68 is for bottom lead current sense resistor 67. A jumper is placed to system ground 69 that allows grounded operation of the harvest coil with system ground 70. More than one step-up transformer coil can be used as energy harvester in the pyramid generator system.

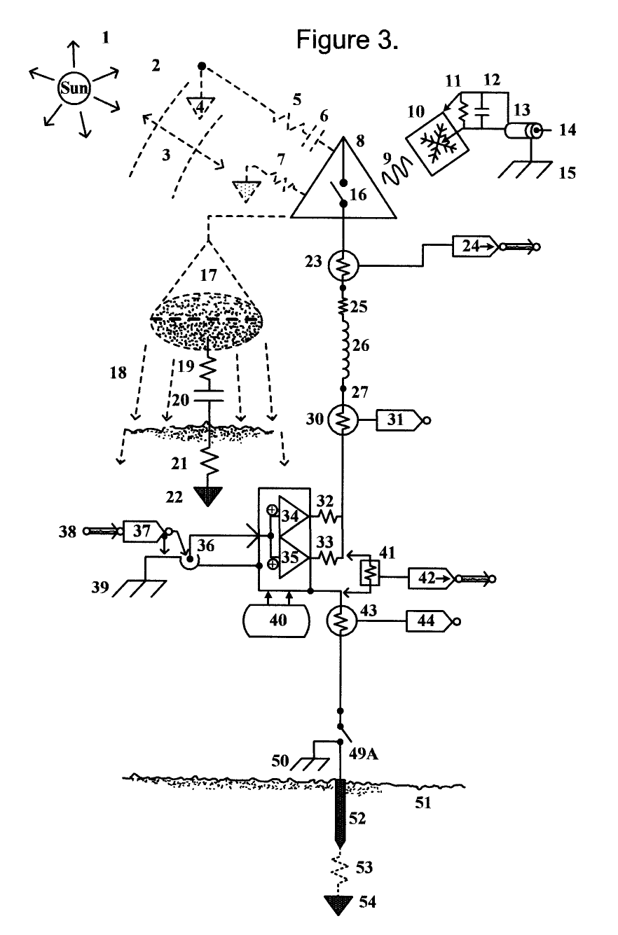

The minimum system is shown in FIG. 3. When a minimum system is used, a load can be directly connected to the pyramid's surface.

### DISCUSSION

This invention demonstrates a novel approach to harvest Earth's electric energy. The masses of Earth and its atmosphere represent a coupled resonant system that is continually electrified by solar radiation. We have found that a pyramidal antenna designed based on the functions of phi and/or pi is optimal for the capture of atmospheric electrostatic discharge (ESD) impulses [3-5]. Atmospheric ESD is a product of solar radiation and is a wide bandwidth phenomenon. The pyramid as a wideband, non-resonant antenna is uniquely adapted to harvest the energy of atmospheric ESD.

This invention also points out an additional energizing mechanism at work during the operation of the pyramid electric generator. The observation is derived from our theory on energy, matter and space [1,2] as well as that of Russell [7]. Both Russell and we observed that spiral motion is a fundamental action of matter and that the vortex is the mechanism of power multiplication in Nature. A vortex concentrates power into its apex where the highest velocity of motion, the highest pressure and the highest electric potential resides [1, 2, 6, 7]. As electricity propagates along a pulsating phi-based spiral [6,7], a phi-based antenna/waveguide is suitable to focus its energy into the apex of a vortex inside the antenna. A phi-based pyramid is optimal for this purpose.

As atomic bodies can oscillate in a very wide frequency range [1, 2, 7, 8], a pyramidal antenna/waveguide coupled to an oscillator that is tuned to a suitable frequency can focus the “electric noise” from Earth's atomic oscillators into the apex of the pyramid at a high voltage. Russell observed that energy moves towards the higher potential during its generative cycle [7]; therefore, it is essential that the pyramidal antenna be at a high potential. Our results corroborated this assumption.

For practical reasons on our small pyramid, we have chosen a frequency above the audio range but below the radio frequency spectrum; our antenna was made to emit at the target wavelength. The wavelength of the 50-120 kHz range is 6 km to 25 km, thus allowing energy to be harvested over a large atmospheric domain. As electrical energy propagates in a vortex [6,7], the emitted electric vortex (ionic antenna) over the pyramidal antenna/waveguide increases its “size” and enables it to funnel the same frequency atmospheric electromagnetic radiations back into the antenna. Thus, the pyramid electric generator captures at the selected frequency the energy emitted by Earth's atomic oscillators.

The presence of an electric (ionic) vortex was demonstrated by radar testing of the space over a 44 m tall fiberglass pyramid located near Moscow [12]. The Russians found that the large ionized column of air over the area of the vertical axis of the pyramid had a width of about 500 m and reached an altitude of 2 km. It is remarkable that this effect was induced by a nonconductive pyramid surface and demonstrating a significant degree of atmospheric ionization even under fair weather conditions. Thus, a suitably sized large or an electrically activated small pyramid should open a low impedance path to higher elevations of relatively conductive atmospheric domains.

In conclusion, the total power that can be extracted from Earth's atomic oscillators must be extremely large, likely far exceeding current global electric generation capacity. In our experiment, we measured over 196 kVA power at the pyramid's apex at about 200 kV p-p voltage using a 6.26 feet base length pyramid. This power is 175 times greater than the power necessary to drive the pyramid to this operating voltage. By constructing the pyramid generator from appropriate high voltage components and using higher drive voltages, a significant increase in power output is envisioned. The power extraction will also be enhanced by further optimization of the designs of both the pyramid and the coil system.

The power output will also increase by employing larger pyramid structures and coils. As voltage is the primary factor in attracting power into the system, the necessary voltage can be provided by the vertical atmospheric potential on a tall pyramid. Since the atmospheric vertical potential gradient could go as high as 1200 V/m near Earth's surface under fair weather conditions [13], a pyramid height of 20-150 m seems sufficient to provide the apex voltage for a self-sustaining power generator. As the pyramid scales up volumetrically, a power generator pyramid of the size range of the GPG could likely have an output in the range of hundreds of gigawatts. Groups of several pyramid electric generators could be placed within specific geographical areas, thus combining their energy harvesting capacity.

### REFERENCES

The following references are specifically applicable to the Example and are incorporated herein in their entirety by this reference; these references are referenced in the Example by the reference numbers assigned to them.
[1] Grandics, P. 2002, “The genesis of electromagnetic and gravitational forces.” J. New Energy, 6, (3) 33-45.
[2] Grandics, P. 2007, “The genesis of fundamental forces acting at a distance and some practical derivations.” Infinite Energy, 12, (71) 13-24.
[3] Grandics, P. 2000, “A method to capture atmospheric electrostatic energy”, in Proceedings of IEJ-ESA Joint Symposium on Electrostatics, Kyoto University, Kyoto, Japan, pp. 355-361.
[4] Grandics, P. 2006, “A DC to RF converter for the capture of atmospheric electrostatic energy”, in Proceedings of the 5^{th} Conference of the Societe Francaise D'Electrostatique, SFE 2006, Grenoble, France pp. 279-284.
[5] Grandics, P. 2007, “Pyramidal Electric Transducer: A DC to RF Converter for the Capture of Atmospheric Electrostatic Energy.” Infinite Energy, 13, (73) 20-27.
[6] Grandics, P. 2009, “The pyramid electric generator.” Infinite Energy, 14, (84) 55-59.
[7] Russell, W. 1947, in The Secret of Light, 3^{rd} ed. University of Science and Philosophy, Waynesboro, Va., pp. 218-288.
[8] Russell, W. 1957, in Atomic Suicide? 2^{nd} ed. University of Science and Philosophy, Waynesboro, Va., pp. 129-153.
[9] Nishida, K, Kobayashi, N and Fukao, Y. 2000, “Resonant oscillations between the solid earth and the atmosphere”, Science 287, (5461), 2244-2246.
[10] Tanimoto, T, Um, J, Nishida, K, and Kobayashi, N. 1998, “Earth's continuous oscillations observed on seismically quiet days”, Geophys Res Lett. 25, 1553-1556.
[11] Tanimoto, T. 2001, “Continuous free oscillations: Atmosphere-solid earth coupling”. Ann Rev Earth Planet Sci. 29, 563-584.
[12] http://www.pyramidoflife.com/eng/tests_experiments.html.
[13] Marshall, T C, Rust, W D, Stolzenburg, M, Roeder, WP, and Kriebel, P R. 1999, “A study of enhanced fair-weather electric fields occurring soon after sunrise”. J Geophys Res. 104, 24,455-24,469.

### ADVANTAGES OF THE INVENTION

The present invention provides a new method of tapping Earth's electric energy pool and providing usable power that can be fed into the power grid or supplied by stand-alone power generators. It does so without the need for mechanical energy or the consumption of fossil fuel or the long-term risks associated with power generated by nuclear fission, including the risk of diversion of fissionable material to terrorist aims or the risk posed by the required long-term storage of spent nuclear fuel. Devices according to the present invention can operate virtually continuously with little to no maintenance.

Articles of manufacture and methods according to the present invention possess industrial applicability for the generation, storage, and transmission of electrical energy.

With respect to ranges of values, the invention encompasses each intervening value between the upper and lower limits of the range to at least a tenth of the lower limit's unit, unless the context clearly indicates otherwise. Moreover, the invention encompasses any other stated intervening values and ranges including either or both of the upper and lower limits of the range, unless specifically excluded from the stated range.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed.

All the publications cited are incorporated herein by reference in their entireties, including all published patents, patent applications, literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

I claim:

1. An electric generator for harvesting the energies of atomic oscillators comprising:
(a) an antenna/waveguide that is geometrically optimized having a conducting surface; and
(b) a coil wound with an insulated conductor over a non-conductive coil form, the coil being connected to an AC or AC-DC driver at its bottom lead and, to the conducting surface of the antenna/waveguide by its top lead near the point where the electric field contacts the antenna/waveguide, with the antenna/waveguide serving as a quasi-capacitive series element to provide a specific resonant frequency;
wherein the generator absorbs impulses from Earth's electric oscillations; and
wherein the attracted energy manifests as high voltage sinusoidal waveforms in the coil, representing harvested electrical energy of atomic oscillators and measurable on the leads of the coil.

2. The electric generator of claim 1, wherein the electric generator stimulates and attracts the electric emissions of atomic oscillators by the use of high voltage.

3. The electric generator of claim 1, wherein the antenna/waveguide is designed based on functions of phi and/or pi.

4. The electric generator of claim 1, wherein the antenna/waveguide is of pyramidal shape.

5. The electric generator of claim 1, wherein the antenna/waveguide is placed on an insulating base.

6. The electric generator of claim 1, wherein the antenna/waveguide is at a high voltage during the operation of the generator.

7. The electric generator of claim 1, wherein the antenna/waveguide voltage is measured by using an E-field antenna.

8. The electric generator of claim 1, wherein the antenna/waveguide is connected to an oscillator.

9. The electric generator of claim 8, wherein the oscillator comprises a resonant step-up transformer.

10. The electric generator of claim 1, wherein the height of the pyramid of the electric generator is from about 0.10 m to about 1000 m.

11. The electric generator of claim 1, wherein the base surface area of the pyramid is from about 0.01 m² to about 1,000,000 m².

12. The electric generator of claim 1, wherein the generator is positioned in the general North-South direction.

13. An electric generator for harvesting the energies of atomic oscillators comprising:
(a) an antenna/waveguide that is geometrically optimized having a conducting surface; and
(b) a primary (apex) coil wound with an insulated conductor over a non-conductive coil form, the coil being connected to an AC or AC-DC driver at its bottom lead and, to the conducting surface of the antenna/waveguide by its top lead near the point where the electric field contacts the antenna/waveguide, and the antenna/waveguide serving as a quasi-capacitive series element to provide a specific resonant frequency; and
(c) a secondary coil of smaller diameter than the primary (apex) coil having a greater number of turns than the primary coil, the secondary coil being positioned coaxially within the primary coil and acting as a resonant step-up transformer winding inductively coupled with the apex coil;
wherein the generator absorbs impulses from Earth's electric oscillations; and
wherein the attracted energy manifests as high voltage sinusoidal waveforms in the secondary coil, representing harvested electrical energy of atomic oscillators and measurable on the leads of the secondary coil.

14. The electric generator of claim 13, in which more than one resonant step-up transformer winding is used.

15. The electric generator of claim 13, wherein the electric generator stimulates and attracts the electric emissions of atomic oscillators by the use of high voltage.

16. The electric generator of claim 15, wherein the high voltage is greater than 500 V_{RMS}.

17. The electric generator of claim 13, wherein the antenna/waveguide is designed based on functions of phi and/or pi.

18. The electric generator of claim 13, wherein the antenna/waveguide is of pyramidal shape.

19. The electric generator of claim 13, wherein the antenna/waveguide is placed on an insulating base.

20. The electric generator of claim 13, wherein the antenna/waveguide is at a high voltage during the operation of the generator.

21. The electric generator of claim 13, wherein the antenna/waveguide voltage is measured by using an E-field antenna.

22. The electric generator of claim 13, wherein the antenna/waveguide is connected to an oscillator.

23. The electric generator of claim 22, wherein the oscillator comprises a resonant step-up transformer.

24. The electric generator of claim 13, wherein the primary (apex) coil of the resonant transformer is connected near the point where the electric field contacts the antenna/waveguide.

25. The electric generator of claim 13, wherein the bottom lead of the secondary coil is connected to ground.

26. The electric generator of claim 13, wherein the primary (apex) coil is inductively coupled to the secondary coil.

27. The electric generator of claim 13, wherein the output of the secondary coil is connected to a load.

28. The electric generator of claim 13, wherein the height of the pyramid of the electric generator is from about 0.10 m to about 1000 m.

29. The electric generator of claim 13, wherein the base surface area of the pyramid is from about 0.01 m² to about 1,000,000 m².

30. The electric generator of claim 13, wherein the generator is positioned in the general North-South direction.

31. An electric generator for harvesting the electric emissions of atomic oscillations comprising an oscillator.

32. The electric generator of claim 31, wherein the oscillator operates in the LF or ELF bands.

33. The electric generator of claim 31 wherein the electric generator comprises:
(a) a primary (apex) coil wound with a conductor over a secondary coil, the primary (apex) coil being connected electrically at its bottom lead to a driver operating in the LF or ELF bands while connected by its top lead near the point at which the electric field contacts the conductive surface of the antenna/waveguide; and
(b) a secondary coil of smaller diameter than the primary coil having a greater number of turns than the primary coil, the secondary coil being positioned coaxially within the first coil and acting as a resonant step-up transformer winding inductively coupled with the primary;
wherein said resonant step-up transformer's output voltage exceeds 500 V_{RMS};
wherein the electric generator attracts impulses from Earth's electric oscillations;
and wherein the attracted energy manifests as high voltage sinusoidal waveforms representing harvested electric energy of atomic oscillations in the secondary coil.

34. The electric generator of claim 33, wherein the output of the secondary coil is connected to a load for drawing power from the generator.

35. A method of tapping Earth's electric oscillatory energies comprising the steps of:
(a) positioning the electric generator of claim 1 such that it is exposed to Earth's electric oscillations; and
(b) generating a sinusoidal voltage signal representing harvested electric energy of atomic oscillators by the operation of the generator.

36. A method of tapping Earth's electric oscillatory energies comprising the steps of:
(a) positioning the electric generator of claim 2 such that it is exposed to Earth's electric oscillations; and
(b) generating a sinusoidal voltage signal representing harvested electric energy of atomic oscillators by the operation of the generator.

37. A method of tapping Earth's electric oscillatory energies comprising the steps of:
(a) positioning the electric generator of claim 32 such that it is exposed to Earth's electric oscillations; and
(b) generating a sinusoidal voltage signal representing harvested electric energy of atomic oscillators by the operation of the generator.
